(19) United States
(12) Patent Application Publication
(10) Pub. No.: US 2014/0278852 A1
(43) Pub. Date: Sep. 18, 2014

(54) Method and System for Using Points in a Social Network or Community Marketplace

(71) Applicant: Victor Kulish, San Diego, CA (US)

(72) Inventor: Victor Kulish, San Diego, CA (US)

(21) Appl. No.: 14/210,631

(22) Filed: Mar. 14, 2014

Related U.S. Application Data
(60) Provisional application No. 61/789,339, filed on Mar. 15, 2013.

(51) Int. Cl. G06Q 30/02; G06Q 50/00

(52) U.S. Cl. CPC G06Q 30/0208; G06Q 50/01
USPC 705/14.11

(57) ABSTRACT

A method and system is described for using points in an online transaction between users comprising storing users' points earned from sharing or providing services, storing users' points earned from borrowing or receiving services, establishing a point value for a transaction, adding the transaction point value to a borrowing or receiving user's borrowing points total, and calculating a point value and adding it to a sharing or providing user's sharing points total. Additionally, the borrowing user's sharing points to borrowing points ratio can be used to calculate the point value to be added to the sharing user's sharing points total.

### CROSS REFERENCE TO RELATED APPLICATIONS

This application claims priority from a provisional U.S. patent application No. 61/789,339 filed on Mar. 15, 2013.

### FIELD OF THE INVENTION

Embodiments of the invention generally relate to social networking and online marketplace websites and applications. Specifically, embodiments of the invention relate to methods and systems for using points in an online transaction between users in a social network or marketplace.

### BACKGROUND OF THE INVENTION

Social networking, auction and classified listing websites and applications bring users together to connect and interact. Many users would normally not have access to each other without such websites. It can allow them to participate in an online marketplace, usually involving monetary transactions. There are other websites and applications that create a communal society in which members share and barter with each other, in which no money is involved to motivate participation. Users receive great benefits from interacting with each other, borrowing from each other, and receiving help from volunteers. However, users must rely on a willingness to participate or the charitable nature of individuals to share and volunteer.

### SUMMARY

Without a form of currency, a social network or online marketplace can provide a point system to incentivize users to participate in transactions and other interactions. In accordance with the teachings of the present invention, a method and system for using points in an online transaction between users in a social network or marketplace is provided.

The method comprises storing users' points earned from sharing or providing services, storing users' points earned from borrowing or receiving services, establish a point value for a transaction, adding the transaction point value to a borrowing or receiving user's borrowing points total, and calculating a point value and adding it to a sharing or providing user's sharing points total. Additionally, the borrowing user's sharing points to borrowing points ratio can be used to calculate the point value to be added to the sharing user's sharing points total. This can be done directly by multiplying the transaction point value and the borrowing user's sharing points to borrowing points ratio. It can also be done indirectly by translating the borrowing user's sharing points to borrowing points ratio into a point multiplier and then multiplying the transaction point value and the point multiplier.

Alternatively, the method comprises storing users' points earned or lost from participating in online transactions and interactions, establish a point value for a transaction, subtracting the transaction point value from a borrowing or receiving user's participation points total, calculating a point value and adding it to a sharing or providing user's participation points total. Additionally, the borrowing user's participation points total ratio can be used to calculate the point value to be added to the sharing user's participation points total. This can be done directly by multiplying the transaction point value and the borrowing user's participation points to predetermined control value ratio. It can also be done indirectly by translating the participation points total into a point multiplier and then multiplying the transaction point value and the point multiplier.

The system comprises a database for storing users' points earned from sharing or providing services and storing users' points earned from borrowing or receiving services, a means for establish a point value for a transaction, and a processor that subtracts the transaction point value from a borrowing or receiving user's participation points total and calculates and adds a point value to a sharing or providing user's participation points total.

### BRIEF DESCRIPTION OF THE DRAWINGS

The accompanying drawings taken in conjunction with the detailed description will assist in making the advantages and aspects of the disclosure more apparent.

FIG. 1 is a flow chart showing how points are awarded from a user interaction in a preferred embodiment.

FIG. 2 is the database schema of a preferred embodiment.

### DETAILED DESCRIPTION

Reference will now be made in detail to the present embodiments discussed herein, illustrated in the accompanying drawing. The embodiments are described below to explain the disclosed method and system by referring to the figures using like numerals. It will be nevertheless be understood that no limitation of the scope is thereby intended, such alterations and further modifications, and such further applications of the principles as illustrated therein being contemplated as would normally occur to one skilled in the art to which the embodiments relate.

A method and system for using points to rate a user's participation in the online community marketplace or social network is provided. A user refers to any person who interacts with and uses a social network or online marketplace website or application. This can be done directly or via a client device over a network to a server system. The network can be the internet or other networks such as intranet, LAN or WAN. This can be done through an ASP, including social networking applications, or directly by accessing the application or website, or via an application that accesses such a website, such as an application running on a mobile phone, tablet, PDA, or connected entertainment device such as a smart TV. Users may have previously registered through a user interface, which may require the creation of a login and password, which gives the user exclusive access to his/her personal information and account. During registration, the system checks that user's name, login, and any other identifiers are valid and unique to that user alone. A user's registration information is stored within the database.

Users regularly participate on the social network or marketplace engaging in various interactions and transactions with other users, hereinafter referred to as “transactions.” A user's participation can be tracked with points that are awarded to the user based on how he/she participates. These are stored in a database along with the user's registration information.

In the preferred embodiment, a user has two types of points associated with his/her profile that are used for tracking participation. One point type tracks a person's actions that involve sharing, providing services or volunteering to other users, referred to as “share points”. These share points are awarded for the kind of actions that benefit the community. The other point type tracks a person's actions that involve borrowing, receiving services or receiving help from other users, referred to as “borrow points”. These borrow points are awarded for the kind of actions that benefits the user. For example, in a transaction in which one user loans his/her power tool to another user, the user who owns the drill will receive share points and the borrowing user will receive borrow points. By having 2 types of points, it can be determined whether a user gives or takes more from the community. A larger number of share points indicate that a user shares more than borrows, while a larger number of borrow points indicate that a user borrows more than shares.

In an alternative embodiment, instead of 2 types of points, there is one type of participation point. Sharing causes points to be added to a user's point total. Borrowing causes points to be subtracted from a user's point total. For example, in a transaction in which one user loans his/her power tool to another user, the user who owns the drill will receive points and the borrowing user will lose points. In such an embodiment, it can be determined whether a user gives or takes more from the community by looking at a user's points. A positive number indicates a user shares more than borrows, while a negative number indicates that a user borrows more than shares.

With two types of points, share and borrow, a ratio of the user's share and borrow points can be established. This ratio is used to determine how many share points another user earns when interacting with a given user. By interacting with a user with a higher share to borrow ratio, a user earns more share points. Each transaction has an established point value, possibly set by the system administrator or set by a user according to guidelines set by the system administrator. The ratio can be directly used to calculate how many share points a user earns from a transaction, by multiplying the ratio and the point value of the transaction. Calculations are performed by the system, which retrieves values from the database and later stores values as well.

As illustrated in FIG. 1, a first user loans a power tool to a second user 105 with a share to borrow ratio of 2, as stored in the database. The transaction has a point value of 100 points 110, as determined by the system. The transaction borrow points will be equal to the 100 points from the transaction 120. The transaction share points can be calculated by the system processor using the share to borrow ratio of 2 and the predetermined point value of 100, resulting in 200 share points 115. The calculated transaction share points are added to the user's current share point total in the database 125. The transaction borrow points are added to the user's current borrow point total in the database 130. The first user will earn twice the number of share points than if he had loaned the power tool to a user with a share to borrow ratio of 1. Conversely, a first user, who loans a power tool to a second user with a share to borrow ratio of 1/2, will earn half the number of share points than if he had loaned the power tool to a user with a share to borrow ratio of 1.

The ratio can also be indirectly used to calculate how many share points a user earns by using a predefined table where a share to borrow ratio is translated into a point multiplier. For example, a first user loans a power tool to a second user 105 with a share to borrow ratio of 2. Using a predefined table, a share to borrow ratio of 2 translates to a multiplier of 1.2. The transaction has a predetermined point value of 100 points 110. Again, the transaction borrow points will be equal to the 100 points from the transaction 120. The transaction share points can be calculated by multiplying the multiplier of 1.2 and the predetermined point value of 100, resulting in 120 share points 115. The calculated transaction share points are added to the user's current share point total in the database 125. The transaction borrow points are added to the user's current borrow point total in the database 130. The first user will earn 1.2× the number of share points than if he had loaned the power tool to a user with a share to borrow ratio of 1. Conversely, a first user loans a power tool to a second user with a share to borrow ratio of 1/2. Using the predefined table, a share to borrow ratio of 1/2 translates to a multiplier of 0.8. The first user will earn 0.8× the number of share points than if he had loaned the power tool to a user with a share to borrow ratio of 1.

In the alternative embodiment, where there is only one participation point type, the participation number is used to determine how many share points another user earns when interacting with a given user. By interacting with a user with a positive participation point number, a user earns more share points. In such an embodiment, the use of a control number may be necessary to determine how many points other users earn, by having the system processor calculate a participation points to control number ratio for positive numbers and a control number to participation points ratio for negative numbers. For example, a first user loans a power tool to a second user with a positive number of points, 2000. With a control number of 1000, the points to control ratio is calculated to be 2. The first user may earn twice the number of share points than if he had loaned the power tool to a user with a points to control ratio of 1. Conversely, a first user loans a power tool to a second with a negative number of points, −2000 With a control number of 1000, the control to points ratio is calculated to be 1/2. The first user will earn half the number of share points than if he had loaned the power tool to a user with a control to points ratio of 1.

The participation points can also be indirectly used to calculate how many share points a user earns with a predefined table where the participation points are translated into a point multiplier. For example, a first user loans a power tool to a second user with 2000 participation points. Using the predefined table, a participation point total of 2000 translates to a multiplier of 1.2. The first user may earn 1.2× the number of share points than if he had loaned the power tool to a user with a share to borrow ratio of 1. Conversely, a first user loans a power tool to a second user with a participation points total of −2000. Using the predefined table, a participation point total of −2000 translates to a multiplier of 0.8. The first user will earn 0.8× the number of share points than if he had loaned the power tool to a user with a share to borrow ratio of 1.

Users, who are habitual borrowers, will attain low share to borrow ratios or negative participation points. At some point, the ratio or participation point total may become so low that other users will stop interacting with them or lending to them. Therefore, in order to remain appealing to other users, a user will need to share and participate in a way that contributes to the community. The use of the ratio between share and borrow points or participation point total rewards and incentivizes users to interact and share with each other.

As illustrated in FIG. 2, in the preferred embodiment, database 200 consists of a Users table 205, a Ratio Translation table 210 and a Transactions table 215.

The Users table 205 stores the information of registered users, who interact and transact with other users. The table consists of the name of the user, and may include login and password information. The login and password information, if used, allows the user to securely access their information from the website or application. Additionally, the users table may include the electronic mail address, phone number, IM address, ASP identity. Lastly, the users table may contain the share points and borrow points that have been accumulated by the user.

Sample content for a row in the Users table is provided.

### Name: John Smith

Login: jsmith

### Password: 12345

Email: jsmith@emailme.com

### Phone: 555-555-5555

Identity: jsmith@socialnetwork.com

### Share Points: 2000

### Borrow Points: 1000

The Ratio Translation table 210 is a table that has been prepopulated by the system. It contains specified share to borrow ratios along with point multipliers associated with those ratios. This table can be queried using the share to borrow ratio to retrieve the point multiplier.

Sample content for a row in the Plates table is provided.

### Share to Borrow Ratio: 2

### Point Multiplier: 1.2

The Transactions Table 215 stores all transactions and interactions between users on the system. A transaction consists of the 2 users involved in the transaction, represented by User IDs found in the Users table. The First User is the sharing user, and the Second User is the borrowing user. The table contains the base point total for the transaction, which will be used to determine how many share points and borrow points the 2 users receive from the transaction. There is a description field which provides the details of the transaction.

Sample content for a row in the Transactions table is provided.

First User: tjones
Second User: jsmith

### Points: 100

Description: Tom Jones is loaning his power tool to John Smith for 2 days

Using the sample content of the database, Tom Jones loans his power tool to John Smith, with a value of 100 points. The Users table can be queried where the Login is equal to jsmith to retrieve the Share Points and Borrow Points of borrower John Smith, 2000 and 1000 respectively. The Share to Borrow Ratio can be calculated as 2000 to 1000 or 2. The Ratio Translation table can be queried where the Share to Borrow Ratio is equal to 2 to retrieve the Point Multiplier, 1.2. The result of multiplying 1.2 and 100, 120, is added to Tom Jones's Share Points total. 100 points are added to John Smith's Borrow Points total.

The preceding description contains various embodiments of the invention and no limitation of the scope is thereby intended.

That which is claimed is:

1. A computer-implemented method for using points in an online transaction between users comprising:
storing users' points earned from sharing or providing services;
storing users' points earned from borrowing or receiving services;
establishing a point value for a transaction;
adding the transaction point value to a borrowing or receiving user's borrowing points total;
calculating a point value and adding it to a sharing or providing user's sharing points total.

2. The method of claim 1, wherein the point value added to the sharing user's sharing points total is calculated using the borrowing user's borrowing points and sharing points totals.

3. The method of claim 2, wherein the point value added to the sharing user's sharing points total is calculated by multiplying the transaction point value and the borrowing user's sharing points to borrowing points ratio.

4. The method of claim 2, wherein the point value added to the sharing user's sharing points total is calculated by translating the borrowing user's sharing points to borrowing points ratio into a point multiplier and then multiplying the transaction point value and the point multiplier.

5. A computer-implemented method for using points in an online transaction between users comprising:
storing users' points earned or lost from participating in online transactions;
establishing a point value for a transaction;
subtracting the transaction point value from a borrowing or receiving user's participation points total;
calculating a point value and adding it to a sharing or providing user's participation points total.

6. The method of claim 5, wherein the point value added to the sharing user's participation points total is calculated using the borrowing user's participation points total.

7. The method of claim 6, wherein the point value added to the sharing user's participation points total is calculated by multiplying the transaction point value and the borrowing user's participation points to predetermined control value ratio.

8. The method of claim 6, wherein the points added to the sharing user's participation points total are calculated by translating the participation points total into a point multiplier and then multiplying the transaction point value and the point multiplier.

9. A system comprising:
a database for storing users' points earned from sharing or providing services and storing users' points earned from borrowing or receiving services;
a means for establishing a point value for a transaction;
a processor that subtracts the transaction point value from a borrowing or receiving user's participation points total and calculates and adds a point value to a sharing or providing user's participation points total.

10. The system of claim 9, wherein the processor calculates the point value added to the sharing user's sharing points total using the borrowing user's borrowing points and sharing points totals.

11. The system of claim 10, wherein the processor calculates the point value added to the sharing user's sharing points total by multiplying the transaction point value and the borrowing user's sharing points to borrowing points ratio.

12. The system of claim 10, wherein the processor calculates the point value added to the sharing user's sharing points total by translating the borrowing user's sharing points to borrowing points ratio into a point multiplier and then multiplying the transaction point value and the point multiplier.
